(19) United States
(12) Patent Application Publication
(10) Pub. No.: US 2014/0168688 A1
(43) Pub. Date: Jun. 19, 2014

(54) IMAGE FORMING SYSTEM, IMAGE FORMING APPARATUS, EXTERNAL APPARATUS, COMMUNICATION METHOD AND STORAGE MEDIUM STORING PROGRAM

(71) Applicant: CANON KABUSHIKI KAISHA, Tokyo (JP)

(72) Inventor: Haruki Sato, Tokyo (JP)

(73) Assignee: CANON KABUSHIKI KAISHA, Tokyo (JP)

(21) Appl. No.: 14/092,167

(22) Filed: Nov. 27, 2013

(30) Foreign Application Priority Data
Dec. 18, 2012 (JP) 2012-276112

(51) Int. Cl. G06K 15/00

(52) U.S. Cl. CPC G06K 15/408
USPC 358/1.14

(57) ABSTRACT

In an image forming system including an image forming apparatus that notifies an external apparatus of detection of a failure and the external apparatus that transmits solving information for solving the failure to the image forming apparatus, a type of media associated with the detected failure is decided on, and the solving information is transmitted to the image forming apparatus by using the type of media that was decided on.

### BACKGROUND OF THE INVENTION

1. Field of the Invention

The present invention relates to an image forming system that notifies an external apparatus of detection of a failure.

2. Description of the Related Art

The session initiation protocol (SIP) can be used to establish a virtual session (SIP session) between communication devices on a network and ensure media communication while the session is taking place. The SIP is used in services such as facsimile machines (IPFAX) using an IP telephone or the SIP, and video streaming. Also, a service is known that, when an image forming apparatus such as a printer malfunctions, detects the failure based on failure information (an error code, an alarm code or a jam code) transmitted from the image forming apparatus and then sends a service man. In addition, a technique is also known in which if the failure is one that can be fixed by a user who is using the image forming apparatus, an operating user-specific maintenance video (moving image) is provided from a distribution server to a portable terminal or the like carried by the operating user of the image forming apparatus (Japanese Patent Laid-Open Nos. 2004-310192 and 2010-39945). A service is also known in which when a failure occurs in an image forming apparatus, an operator of the support center asks, through a voice call, the operating user about the malfunction condition and advises the operating user on a course of action to solve the failure, and at the same time, provides a video (moving image) that shows the course of action to solve the failure from a distribution server to the image forming apparatus.

In the case where the image forming apparatus malfunctions, two cases can be conceived depending on the failure: the case where the operating user cannot view the video (moving image) due to the operation panel being broken; and the case where the operating user cannot make a voice call to the call center due to the audio reproduction function being broken. The following two cases are also conceivable depending on the image forming apparatus that has malfunctioned: the case where the image forming apparatus is not provided with an operation panel having a video (moving image) reproduction function; and the case where the image forming apparatus is not provided with an audio reproduction apparatus.

However, with the conventional services, irrespective of the device configuration of the image forming apparatus and the malfunction condition of the image forming apparatus, the type of media for supporting the operating user of the image forming apparatus is pre-set to a particular medium (voice call, or the like). Accordingly, where necessary, the type of media needs to be changed afterward to, for example, streaming of a maintenance video (moving image), so as to support the operating user.

### SUMMARY OF THE INVENTION

An aspect of the present invention is to eliminate the above-mentioned problems with the conventional technology. The present invention provides a mechanism that recognizes an appropriate type of media depending on the failure in the image forming apparatus.

The present invention in one aspect provides an image forming system including: an image forming apparatus including a detecting unit configured to detect a failure and a notifying unit configured to notify an external apparatus of detection of the failure; and the external apparatus including a transmitting unit configured to transmit solving information for solving the failure to the image forming apparatus, the image forming system comprising: a deciding unit configured to decide on a type of media associated with the failure detected by the detecting unit, wherein the transmitting unit transmits the solving information to the image forming apparatus by using the type of media decided on by the deciding unit.

According to the present invention, it is possible to recognize an appropriate type of media depending on the failure in the image forming apparatus.

Further features of the present invention will become apparent from the following description of exemplary embodiments with reference to the attached drawings.

### BRIEF DESCRIPTION OF THE DRAWINGS

FIG. 1 is an image showing a network configuration including an image forming apparatus.

FIG. 2 is a diagram showing a block configuration of hardware of the image forming apparatus.

FIG. 3 is a diagram showing a block configuration of hardware of a host computer.

FIG. 4 is a diagram showing a block configuration of software of the image forming apparatus.

FIG. 5 is a diagram showing a list of continuously available functions and available media.

FIG. 6 is a diagram showing a list of device configurations of image forming apparatuses and available media.

FIG. 7 is a diagram showing a list of model codes and product names of image forming apparatuses.

FIG. 8 is a diagram showing an example of device state information.

FIG. 9 is a diagram showing an example of an SIP_INVITE message.

FIG. 10 is a diagram showing an example of a user interface indicating that an error has occurred.

FIG. 11 is a diagram showing a block configuration of software of the host computer.

FIG. 12 is a diagram showing a procedure of processing performed when a failure has been detected according to a first embodiment.

FIG. 13 is a diagram showing a procedure of processing performed in the host computer.

FIG. 14 is a diagram showing a communication sequence between the image forming apparatus and the host computer.

FIG. 15 is a diagram showing an example of an OK response message.

FIG. 16 is a diagram showing a procedure of processing performed when a failure has been detected according to a second embodiment.

FIG. 17 is a diagram showing a procedure of processing performed in the host computer.

FIG. 18 is a diagram showing a communication sequence between the image forming apparatus and the host computer.

FIG. 19 is a diagram showing an example of an SIP_INVITE message.

FIG. 20 is a diagram showing an example of an ACK message.

### DESCRIPTION OF THE EMBODIMENTS

Preferred embodiments of the present invention will now be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention. In the following, the same constituent elements are given the same reference numerals, and descriptions thereof are omitted.

### First Embodiment

In the present embodiment, a description will be given of processing, performed by an image forming apparatus having a print function and the like, for determining the type of media used in an SIP session based on a failure condition and a device configuration of the image forming apparatus.

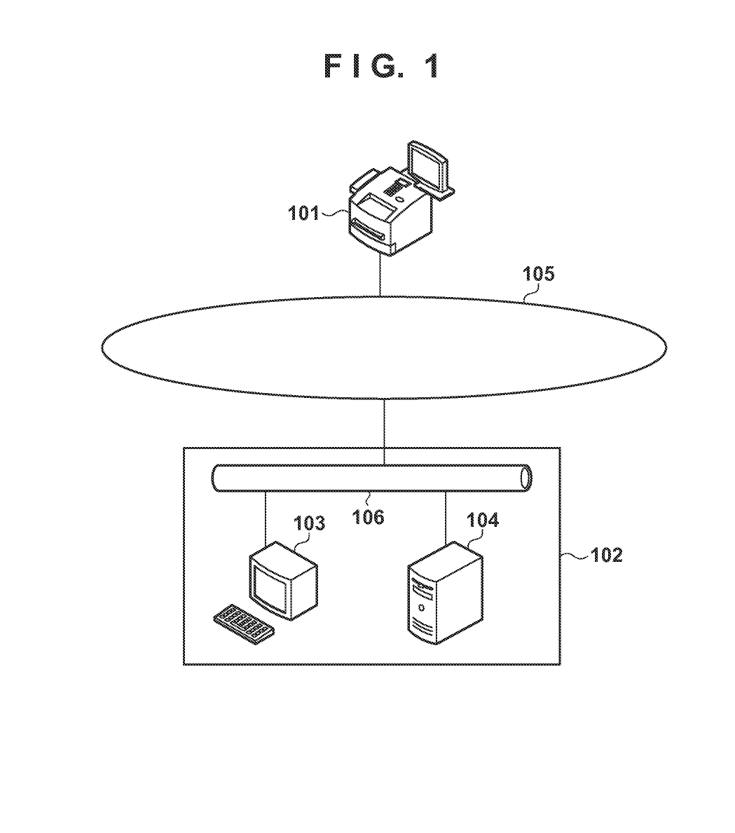

FIG. 1 is a diagram showing a configuration of an image forming system including an image forming apparatus. In FIG. 1, an image forming apparatus 101 and a call center system 102 are connected so as to be capable of communication with each other via a network system 105 such as the Internet. The image forming apparatus 101 may be connected to a plurality of network systems 105. If a failure occurs in the image forming apparatus 101, the image forming apparatus 101 notifies the call center system 102 of the failure in response to an instruction from an operating user (user) of the image forming apparatus 101. Upon receiving the notification, the call center system 102 provides information required for maintenance of the image forming apparatus 101 to the image forming apparatus 101.

The call center system 102 includes a host computer 103 and a database 104, and the host computer 103 and the database 104 are connected so as to be capable of communication with each other via a LAN 106. The LAN 106 is connected to the network system 105, and under control of the host computer 103, the call center system 102 and the image forming apparatus 101 can communicate with each other. The database 104 may be physically provided within the host computer 103, but as long as the host computer 103 can access, the database 104 may be provided in any other location that is connected via the network system 105. Also, in FIG. 1, one host computer 103 and one database 104 are provided, but for the purpose of, for example, load distribution, a plurality of host computers 103 and a plurality of databases 104 may be provided.

The image forming apparatus 101 and the host computer 103 each have a media communication function using an SIP. As used herein, the SIP is a session initiate protocol. Also, the media communication refers to, for example, voice calling, transmission and reception of video (moving image), internet facsimile communication (IPFAX) according to T.38 which is an ITU-T recommendation, transmission and reception of data, and the like performed between the operating user of the image forming apparatus 101 and an operator of the host computer 103. The image forming apparatus 101 may have other functions such as a copy function, a print function and a scan function. In other words, the image forming apparatus 101 may be a multifunctional peripheral (MFP) having an integrated configuration for implementing a plurality of functions.

The database 104 stores therein the model code of the image forming apparatus 101 supported by the call center system 102, maintenance videos (moving images) related to failure information, instruction manual data and the like. The host computer 103 acquires data stored in the database 104 and transmits the data to the image forming apparatus 101. Communication control on the network system 105 and the LAN 106 is executed by the internet protocol (IP).

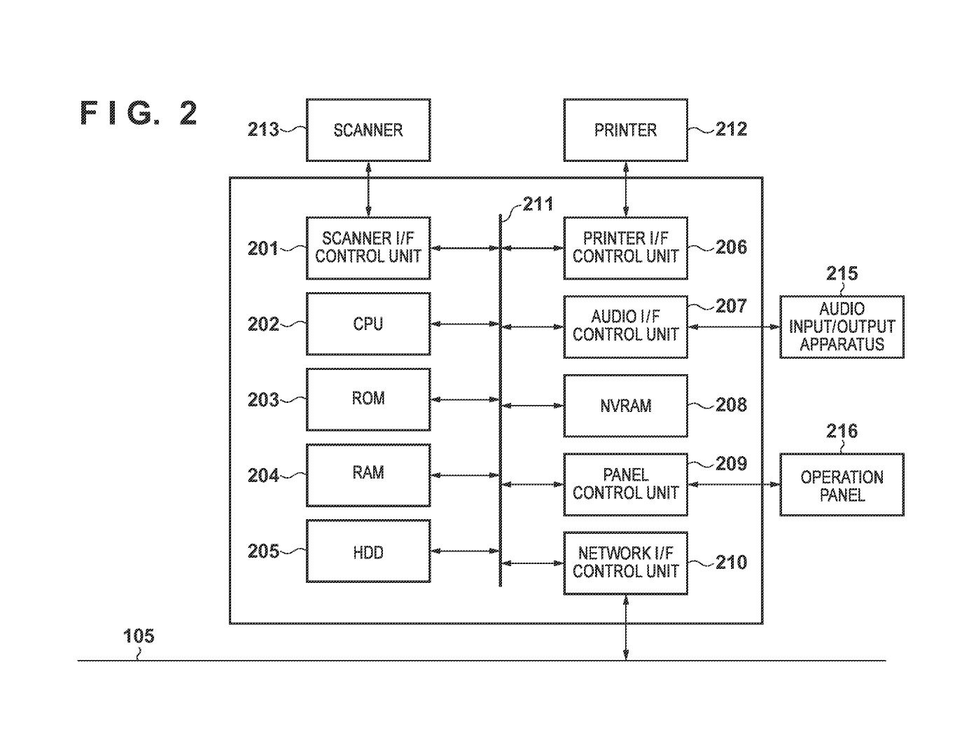

FIG. 2 is a diagram showing a block configuration of hardware of the image forming apparatus 101. Here, a description will be given by using, as an example, a copying machine as the image forming apparatus 101. A CPU 202 performs overall control on various types of devices connected to a system bus 211 based on a control program stored in a ROM 203 or a hard disk (HDD) 205. Also, the CPU 202 outputs an image signal to a printer 212 connected via a printer interface (I/F) control unit 206. Also, the CPU 202 processes an image signal that is input from a scanner 213 connected via a scanner interface (I/F) control unit 201. Also, the CPU 202 processes an audio signal that is input to or output from an audio input/output apparatus 215 connected via an audio interface (I/F) control unit 207.

A program ROM included in the ROM 203 stores therein a control program and the like that can be executed by the CPU 202. A data ROM included in the ROM 203 stores therein various types of data that can be used by the image forming apparatus 101. The CPU 202 controls communication with an apparatus connected to the network system 105 via a network interface (I/F) control unit 210. A RAM 204 primarily functions as a main memory, a work area and the like for the CPU 202. Also, the RAM 204 can expand the memory capacity by using an optional RAM connected to an additional port (not shown). The hard disk (HDD) 205 stores therein application programs, font data, form data and the like, and is used as a job storage area for temporarily spooling print jobs. The jobs spooled in the HDD 205 can be controlled from outside. Also, the HDD 205 is used as a box data storage area for storing image data read by the scanner 213 and image data of a print job as box data, and the data can be referred to or printed through an external network. In the present embodiment, other than the HDD 205, an external storage device such as an SD card or a flash memory may be used. A nonvolatile memory (NVRAM) 208 stores therein various types of settings information set by the user through an operation panel 216 via a panel control unit 209. The network interface (I/F) control unit 210 implements data communication with the network system 105 via a network cable.

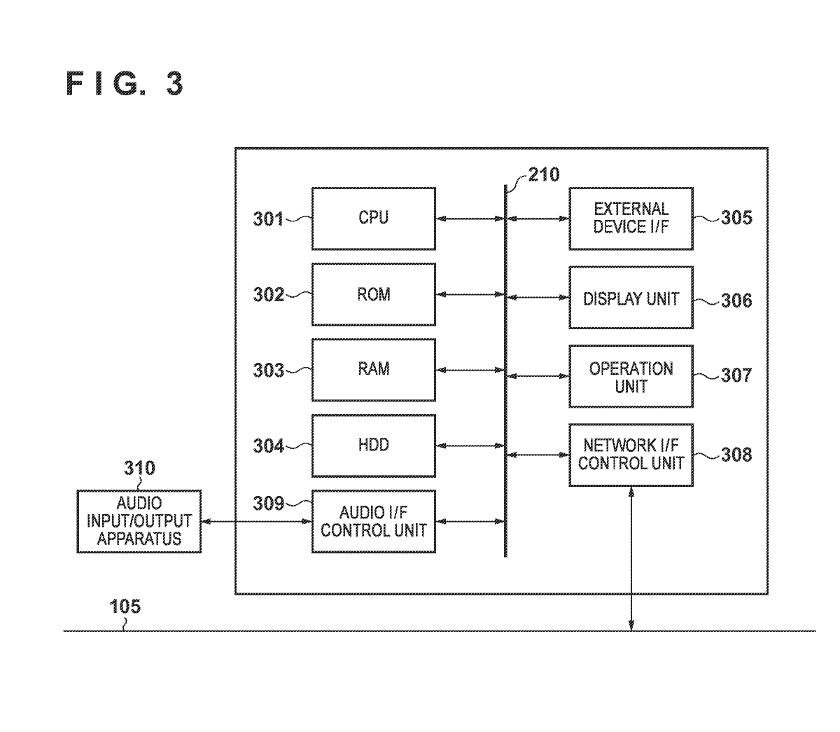

FIG. 3 is a diagram showing a block configuration of hardware of the host computer 103. A CPU 301 performs overall control on various types of devices connected to a system bus 310 based on a control program stored in a ROM 302 or a hard disk (HDD) 304. The ROM 302 is an unwritable nonvolatile memory that stores therein programs and data related to various types of processing of the host computer 103. A RAM 303 is a writable volatile memory that stores therein temporary data related to various types of processing of the host computer 103. The hard disk (HDD) 304 stores therein programs, data, temporary data and the like related to various types of processing of the host computer 103. An external device interface (I/F) 305 connects an external storage device or the like to the host computer 103. A display unit 306 displays the operational status of the host computer 103, information output by each program executed by the host computer 103, and the like. An operation unit 307 is, for example, a keyboard or a pointing device for receiving (accepting) input of an instruction given from the operator to the host computer 103. A network interface (I/F) control unit 308 connects the host computer 103 to the LAN, and implements communication with an external apparatus. An audio interface (I/F) control unit 309 connects an audio input/output apparatus 310 to the host computer 103.

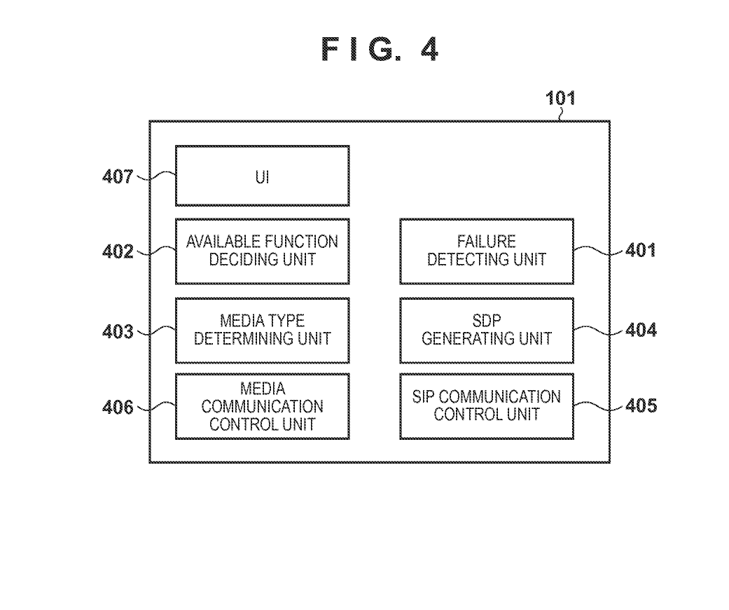

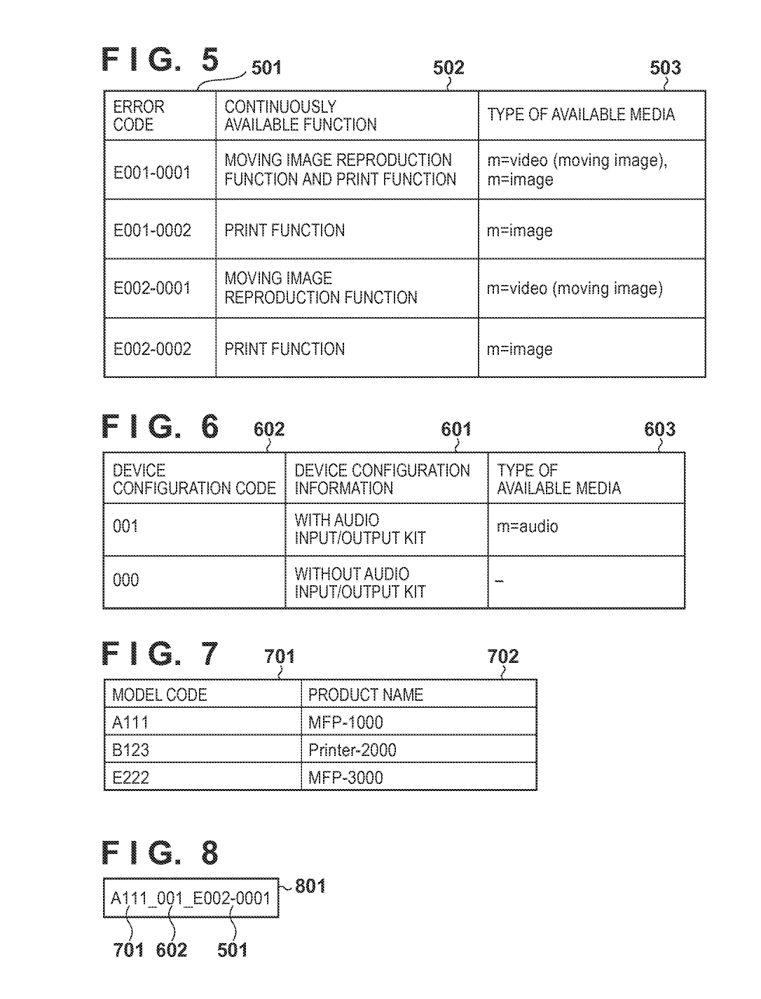

FIG. 4 is a diagram showing a block configuration of software of the image forming apparatus 101. FIG. 4 will be described with reference to FIGS. 5, 6, 7, 8 and 9, which will be described later. A failure detecting unit 401 monitors the state of the image forming apparatus 101, detects a failure, and displays on the operation panel 216 a user interface (UI) screen notifying the user of the detected failure, and at the same time notifies an available function deciding unit 402 of the failure. Upon receiving, from the operation panel 216, an instruction to provide a notification to make a call to the call center system 102, the available function deciding unit 402 decides on a continuously available function 502 that can be used continuously by the image forming apparatus 101 based on an error code 501. A media type determining unit 403 determines the type of media used in an SIP session established between the image forming apparatus 101 and the host computer 103 based on a type of available media 503 associated with the continuously available function 502, and device configuration information 601. An SDP generating unit 404 generates an SDP 903 in which the determined available media 503 is written in a media descriptive portion 905. As used herein, the SDP refers to a session description protocol that is used to write session information according to the type of media in an SIP message.

An SIP communication control unit 405 controls an SIP session for media communication by performing generation and analysis of an SIP message and transmission and reception of the SIP message via the network I/F control unit 210. The SIP communication control unit 405 configures, when transmitting a request to establish an SIP session to the host computer 103, a model code 701, a device configuration code 602 and a failure code 501 of the image forming apparatus 101 as device state information 801. Then, the SIP communication control unit 405 stores the device state information 801 in a User-Agent header 904 of the SIP message, and generates an SIP_INVITE message 901. The SIP communication control unit 405 transmits the generated SIP_INVITE message 901 to the host computer 103. A media communication control unit 406 controls media communication according to the SIP session controlled by the SIP communication control unit 405. A UI 407 controls the display of the user interface screen.

FIG. 5 is a table showing a list of continuously available functions and available media in association with error codes in the image forming apparatus 101. The image forming apparatus 101 stores the table shown in FIG. 5 in the HDD 205. Also, the host computer 103 stores, for each image forming apparatus 101 supported by the call center system 102, a table as shown in FIG. 5 in the HDD 304. Item 501 shows a list of error codes to be controlled. Item 502 indicates functions that can be continuously used by the image forming apparatus 101 when a failure corresponding to any one of the error codes 501 has occurred. Item 503 indicates the type of media for media communication that can be received from, for example, an external apparatus, which is used by a function indicated by Item 502. In the case of FIG. 5, if a failure having an error code of “E002-0001” occurs, the continuously available function is a video (moving image) reproduction function, and the type of available media is “video”. In other words, by referring to the table shown in FIG. 5, the host computer 103 can identify the failure that has occurred in the image forming apparatus 101 and a continuously available function. Note that FIG. 5 is merely an example, and thus the content of Items 501 to 503 is not specifically limited to that shown in FIG. 5. Examples of error codes include a jam code, an alert code and the like.

FIG. 6 is a table showing the device configuration of the image forming apparatus 101 and the type of available media corresponding to each device configuration. The image forming apparatus 101 stores the table shown in FIG. 6 in the HDD 205. Also, the host computer 103 stores, for each image forming apparatus 101 supported by the call center system 102, a table as shown in FIG. 6 in the HDD 304. In the table shown in FIG. 6, device configuration information 601 of the image forming apparatus 101, a device configuration code 602 corresponding to each device configuration and a type of available media 603 are associated with each other. In the case of FIG. 6, if the device configuration code 602 is “001”, it indicates that the image forming apparatus 101 includes an audio input/output kit and thus can use audio media. In other words, by referring to the table shown in FIG. 6, the host computer 103 can identify the device configuration of the image forming apparatus 101. Note that FIG. 6 is merely an example, and thus the content of Items 601 to 603 is not specifically limited to that shown in FIG. 6.

FIG. 7 is a diagram showing a table in which the model code and the product name assigned to the image forming apparatus 101 are associated with each other. The host computer 103 stores the table shown in FIG. 7 in the HDD 304. The host computer 103 can uniquely identify the product name from the model code by referring to the table shown in FIG. 7 in which model codes 701 and product names 702 are associated with each other. Note that FIG. 7 is merely an example, and thus the content of Items 701 and 702 is not specifically limited to that shown in FIG. 7.

FIG. 8 is a diagram showing an example of the device state information 801 that is notified by the image forming apparatus 101 to the host computer 103. The device state information 801 includes a model code 701, a device configuration code 602 and an error code 501. FIG. 8 indicates that the model code is “A111”, the device configuration is “001” indicating that an audio input/output kit is provided, and a failure corresponding to the error code “E002-0001” has occurred. Note that FIG. 8 is merely an example, and thus the constituent elements of the device state information 801 may be only an error code or may be only a model code.

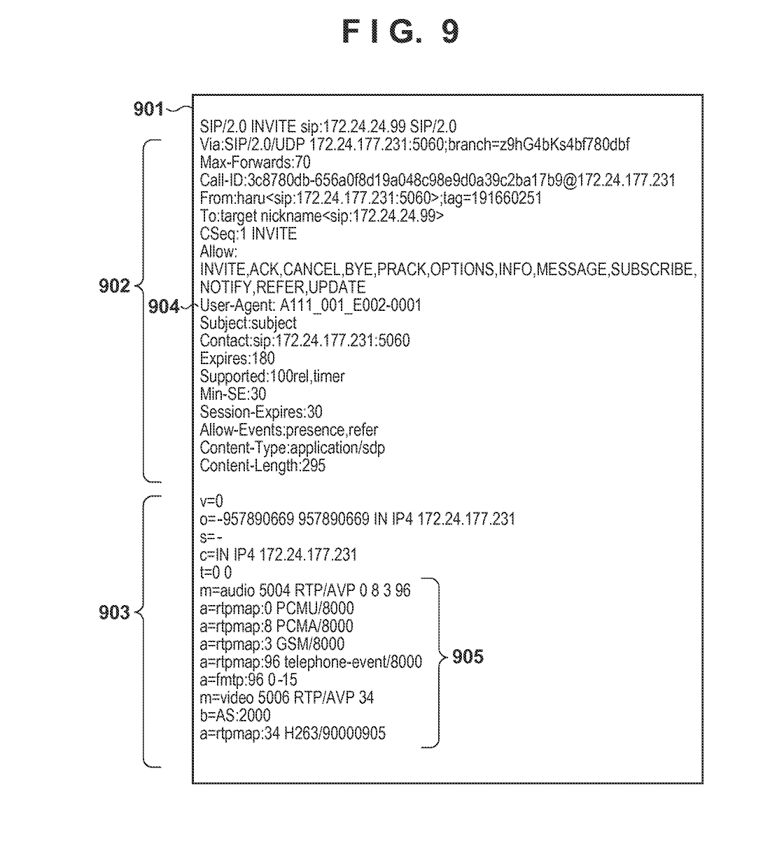

FIG. 9 is a diagram showing an example of the INVITE message 901 transmitted from the image forming apparatus 101. A header portion 902 is an SDP header portion of the INVITE message 901. A body portion 903 is an SDP body portion of the INVITE message 901. In the case of FIG. 9, in a User-Agent header portion 904 of the header portion 902, the device state information 801 is written. Also, in a media descriptive portion 905 regarding media of the body portion 903, the type of media determined by the media type determining unit 403 is written. Note that FIG. 9 is merely an example, and thus the content of the INVITE message 901 is not specifically limited to that shown in FIG. 9.

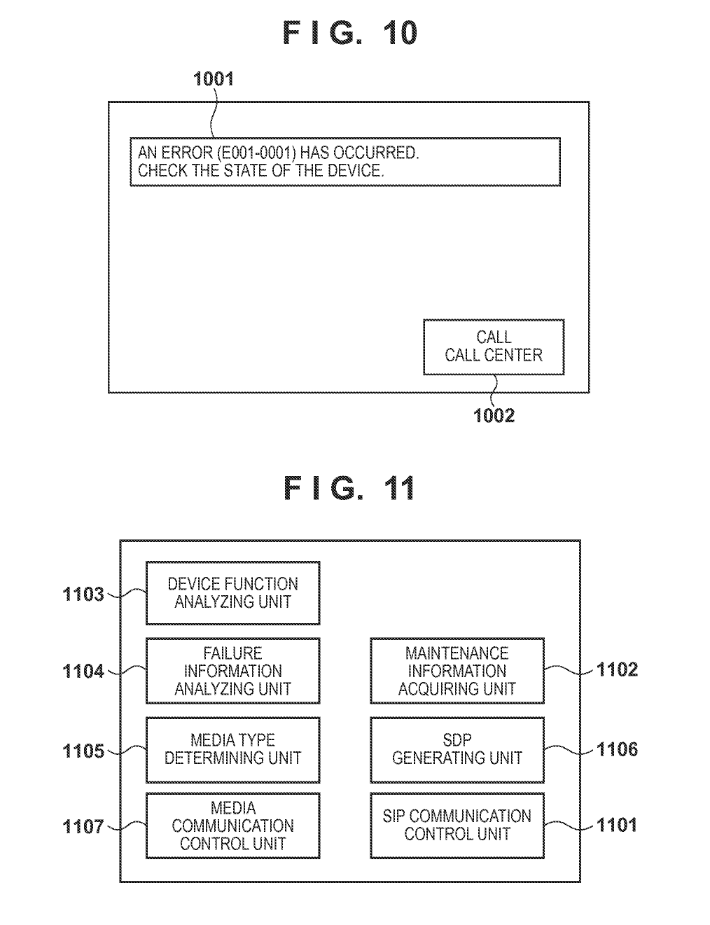

FIG. 10 is a diagram showing an example of a user interface for notifying the operating user of the occurrence of an error (failure) in the image forming apparatus 101 and notifying the call center system 102 of the occurrence of the error. An indication 1001 is a message portion for informing the operating user of failure information that has occurred in the image forming apparatus 101. By a button 1002 being pressed by the operating user, a notification indicating that an error has occurred in the image forming apparatus 101 can be sent to the call center system 102.

FIG. 11 is a diagram showing a block configuration of software of the host computer 103. An SIP communication control unit 1101 controls an SIP session for media communication by performing generation and analysis of an SIP message and transmission and reception of the SIP message via the network I/F control unit 308. A maintenance information acquiring unit 1102 acquires a necessary maintenance video (moving image) from the database 104. A device function analyzing unit 1103 recognizes, by referring to the device state information 801, a function that can be used by the device that has accessed the host computer 103 with the use of a notification or the like indicating that a failure has occurred. A failure information analyzing unit 1104 recognizes the details of the failure that has occurred in the device that has accessed the host computer 103 due to the occurrence of a failure or the like by referring to the error code 501 of the device state information 801. A media type determining unit 1105 determines the type of media used in an SIP session established between the image forming apparatus 101 and the host computer 103. An SDP generating unit 1106 generates an SDP 903 in which the type of media used in the SIP session is written in the media descriptive portion 905. A media communication control unit 1107 controls media communication corresponding to the SIP session controlled by the SIP communication control unit 1101.

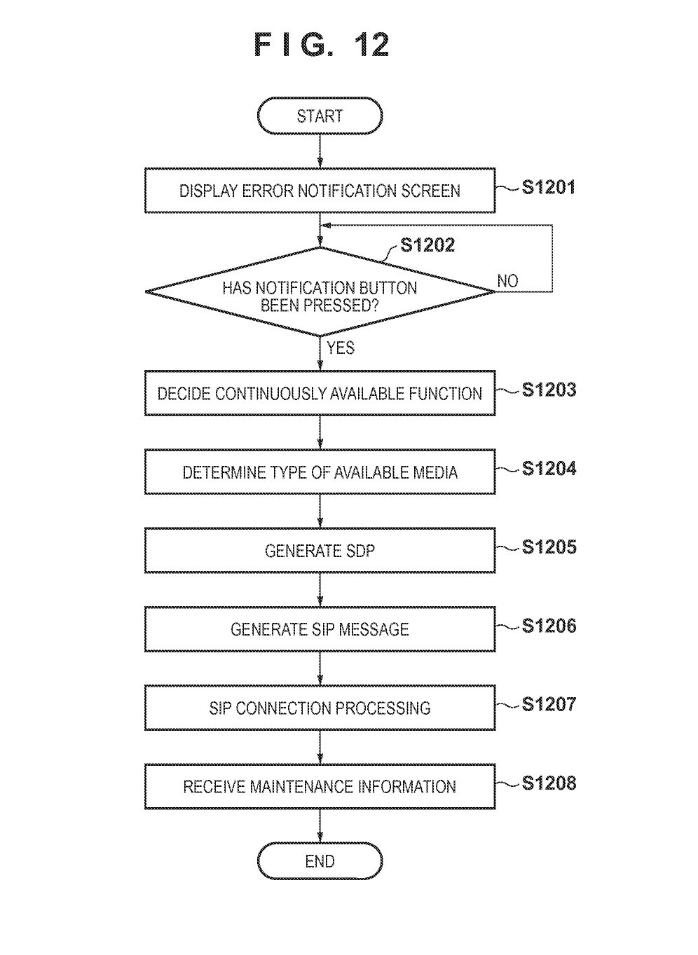

FIG. 12 is a flowchart illustrating a procedure of processing performed when the image forming apparatus 101 has detected a failure by using the failure detecting unit 401. Each processing shown in the flowchart is implemented by, for example, a program stored in the ROM 203 being read into the RAM 204 and executed by the CPU 202.

In step S1201, the UI 407 displays an error notification screen as shown in FIG. 10 on the operation panel 216 via the panel control unit 209. In step S1202, if the UI 407 detects, via the panel control unit 209, that the notification button 1002 on the error notification screen displayed on the operation panel 216 has been pressed, the procedure advances to step S1203.

In step S1203, the available function deciding unit 402 decides on a continuously available function 502 of the image forming apparatus 101 based on the error code 501 of the failure that has occurred. In the case where, for example, the error code 501 corresponding to the failure that has occurred is “E002-0001”, the available function deciding unit 402 decides that the video (moving image) reproduction function can be continuously used. In step S1204, the media type determining unit 403 determines the type of media used in an SIP session established with the host computer 103 based on the type of available media 503 associated with the continuously available function 502, and the device configuration information 601. In the case where, for example, the error code 501 is “E002-0001”, and the device configuration information is “With audio input/output kit”, “audio” and “video” are determined as the types of available media. In step S1205, the SDP generating unit 404 generates the body portion 903 in which the types of available media are written in the media descriptive portion 905.

In step S1206, the SIP communication control unit 405 configures the model code 701, the device configuration code 602 and the failure code 501 of the image forming apparatus 101 as the device state information 801, and writes the device state information 801 in the User-Agent header 904 of the SIP message. Next, the SIP communication control unit 405 generates the SIP_INVITE message 901 including the header portion 902 and the body portion 903. In step S1207, the SIP communication control unit 405 transmits the SIP_INVITE message 901 to the host computer 103 via the network I/F control unit 308 so as to establish an SIP session.

In step S1208, the media communication control unit 406 performs media communication corresponding to the SIP session controlled by the SIP communication control unit 405, and performs audio input/output processing, video (moving image) reproduction processing, and print processing according to the type of media. For example, in the case of performing “audio” media communication, the media communication control unit 406 implements a voice call using audio data between the operating user of the image forming apparatus 101 and the operator of the call center system 102 via the audio I/F control unit 207. In the case of performing “video” media communication, if maintenance video (moving image) data is transmitted from the host computer 103 via the panel control unit 209, the media communication control unit 406 reproduces the maintenance video (moving image) on the operation panel 216. In the case of performing “print” media communication other than the “audio” media communication and the “video” media communication, the media communication control unit 406 performs printing based on print data transmitted from the host computer 103.

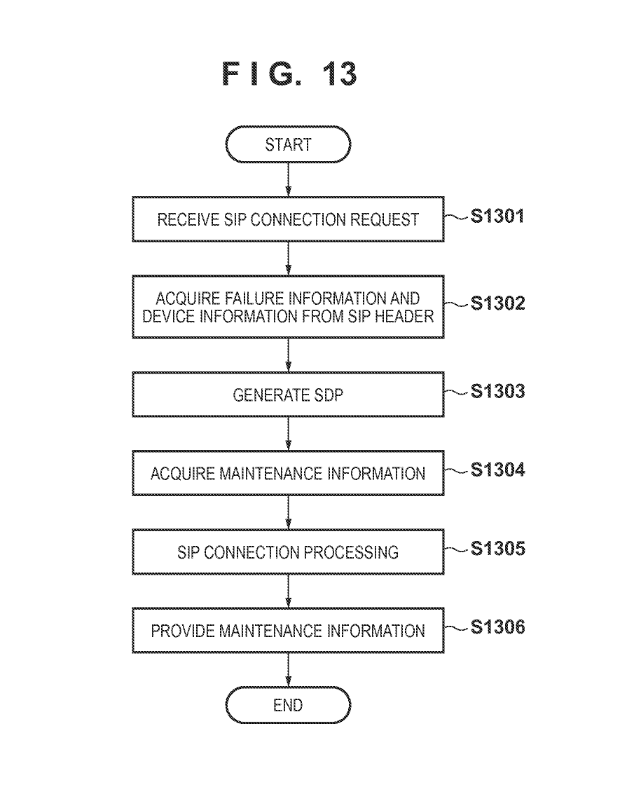

FIG. 13 is a flowchart illustrating a procedure of processing performed when the host computer 103 has received the SIP_INVITE message 901 from the image forming apparatus 101 through the SIP communication control unit 1101. Each processing shown in the flowchart is implemented by, for example, a program stored in the ROM 302 being read into the RAM 303 and executed by the CPU 301.

In step S1301, the SIP communication control unit 1101 receives the SIP_INVITE message 901 via the network I/F control unit 308. In step S1302, the failure information analyzing unit 1104 refers to the User-Agent header 904 written in the header portion 902 of the SIP_INVITE message 901, then acquires the device state information 801, and identifies the details of the failure that has occurred in the image forming apparatus 101 based on the error code 501. Also, the failure information analyzing unit 1104 identifies the model information of the image forming apparatus 101 based on the model code 701. For example, in the case where the device state information 801 as shown in FIG. 8 has been acquired, it can be seen that the image forming apparatus 101 is “MFP-1000”.

In step S1303, the SDP generating unit 1106 generates a body portion 1503 in which the type of media written in the media descriptive portion 905 of the SIP_INVITE message 901 received in step S1301 is written as the type of media used in the SIP session. For example, in the case where the SIP_INVITE message 901 has been received, “audio” and “video” are written in a media descriptive portion 1504 as the types of media used in the SIP session. In step S1304, the maintenance information acquiring unit 1102 acquires, from the database 104, the details of the failure and the model information identified in step S1302, and the maintenance information corresponding to the type of media used in the SIP session. For example, in the case where “video” is used, the maintenance information acquiring unit 1102 acquires maintenance video (moving image) data.

In step S1305, the SIP communication control unit 1101 generates a 200 OK response message 1501 containing the body portion 1503 generated in step S1303, and transmits the generated 200 OK response message 1501 to the image forming apparatus 101 via the network I/F control unit 308 so as to establish an SIP session. In step S1306, the media communication control unit 1107 performs media communication according to the SIP session controlled by the SIP communication control unit 1101, and performs audio input/output processing, video (moving image) reproduction processing, print processing or the like according to the type of media. For example, in the case where media communication consisting of “audio” and “video” communication is performed, the media communication control unit 1107 implements a voice call between the operating user of the image forming apparatus 101 and the operator of the call center system 102 via the audio I/F control unit 309. Also, at this time, the host computer 103 provides the maintenance video (moving image) data acquired from the database 104 to the image forming apparatus 101.

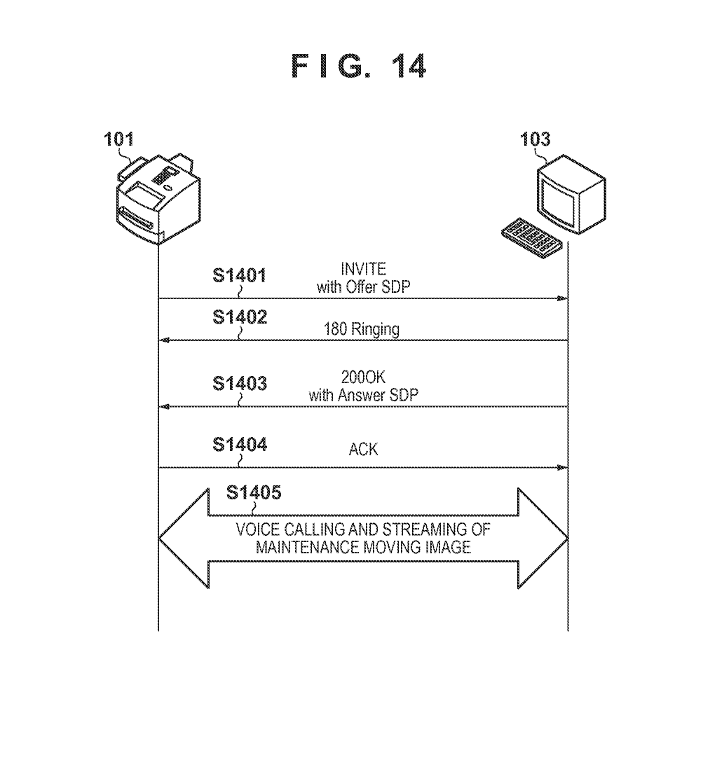

FIG. 14 is a diagram showing an example of a communication sequence between the image forming apparatus 101 and the host computer 103. Hereinafter, FIG. 14 will be described in association with FIGS. 12 and 13. In steps S1207 and S1301, the image forming apparatus 101 transmits an SIP_INVITE message 901 to the host computer 103 (step S1401). Upon receiving the SIP_INVITE message 901, the host computer 103 returns a 180 Ringing response (step S1402). Next, the host computer 103 performs the processing of steps S1302 to S1304 shown in FIG. 13, and then, in step S1305, returns a 200 OK response message indicating permission to establish an SIP session (step S1403). Next, upon receiving the 200 OK response message 1501, the image forming apparatus 101 transmits an ACK message to the host computer 103 (step S1404) so as to establish an SIP session. When the SIP session has been established, the image forming apparatus 101 and the host computer 103 perform media communication with each other (step S1405). The media communication is performed by, for example, voice calling, streaming of maintenance video (moving image) data from the host computer 103, or the like.

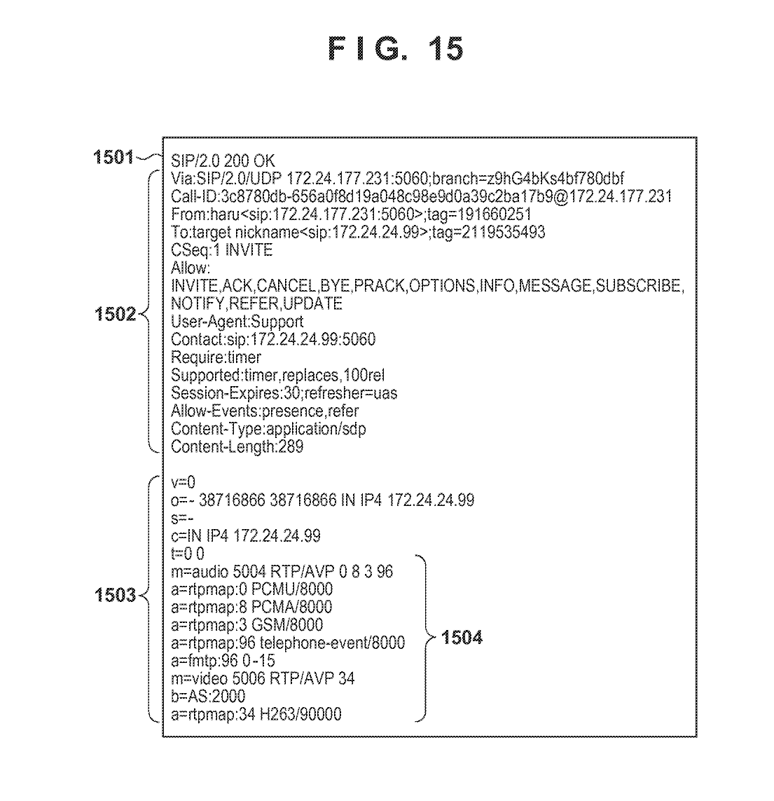

FIG. 15 is a diagram showing an example of the 200 OK response message 1501 transmitted by the host computer 103. A header portion 1502 is an SIP header portion containing the above-described 200 OK response. The body portion 1503 is an SDP body portion of the 200 OK response. In the media descriptive portion 1504 of the SDP body portion, the type of media used in the SIP session is written. Note that FIG. 15 is merely an example, and thus the content of the 200 OK response message is not specifically limited to that shown in FIG. 15.

As described above, in the present embodiment, the image forming apparatus 101 can detect the type of media that can be output to the operating user based on the malfunction condition and the device configuration of the image forming apparatus 101 and request the call center system 102 to provide a service by using the detected type of media. As a result, the operating user can recognize an operation that needs to be performed on the image forming apparatus 101 more rapidly than the conventional apparatuses.

### Second Embodiment

In the present embodiment, a configuration will be described in which the host computer 103 acquires the model, the failure condition and the device configuration of the image forming apparatus 101, and determines the type of media used in an SIP session based on the acquired information.

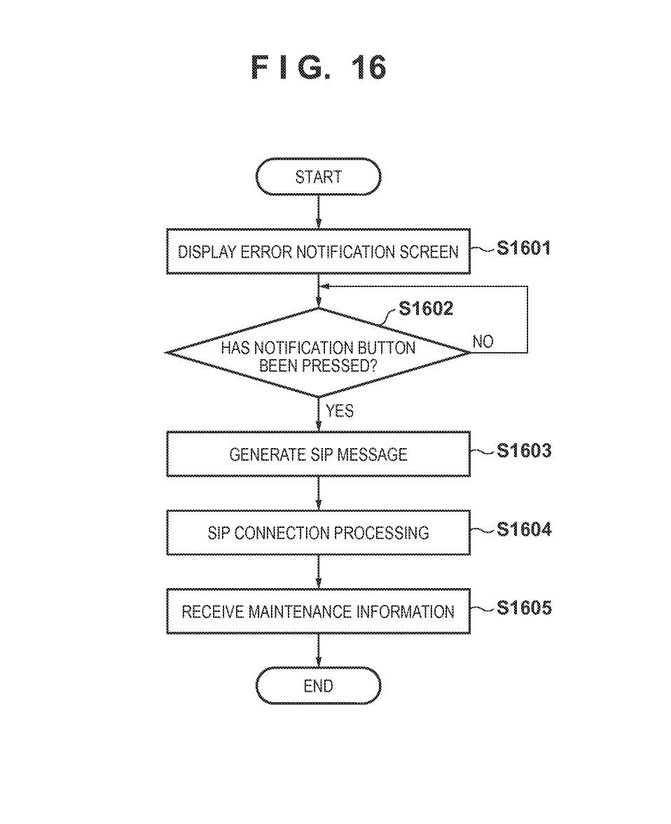

FIG. 16 is a flowchart illustrating processing performed when the image forming apparatus 101 has detected a failure by using the failure detecting unit 401 according to the present embodiment. Each processing shown in the flowchart is implemented by, for example, a program stored in the ROM 203 being read into the RAM 204 and executed by the CPU 202.

In step S1601, the failure detecting unit 401 displays an error notification screen shown in FIG. 10 on the operation panel 216 via the panel control unit 209. In step S1602, when the UI 407 detects via the panel control unit 209 that the notification button 1002 on the error notification screen on the operation panel 216 has been pressed, the procedure advances to step S1603. In step S1603, the SIP communication control unit 405 configures the model code 701, the device configuration code 602 and the failure code 501 of the image forming apparatus 101 as device state information 801, and writes the device state information 801 in a User-Agent header 1903 of an SIP message. Then, the SIP communication control unit 405 generates an SIP_INVITE message 1901 that does not contain an SDP body portion. In step S1604, the SIP communication control unit 405 transmits the SIP_INVITE message 1901 to the host computer 103 via the network I/F control unit 210.

Next, the SIP communication control unit 405 receives a 200 OK response message 1501 from the host computer 103 via the network I/F control unit 210. Next, the SDP generating unit 404 generates a body portion 2003 containing a media descriptive portion 2004 in which the type of media written in the media descriptive portion 1504 of the 200 OK response message 1501 is written as the type of media used in an SIP session. The type of media can be, for example, “audio” and “video”. Next, the SIP communication control unit 405 generates an ACK message 2001 containing the body portion 2003 and transmits the generated ACK message 2001 to the host computer 103 so as to establish an SIP session.

In step S1605, the media communication control unit 406 performs media communication according to the SIP session controlled by the SIP communication control unit 405, and performs audio input/output processing, video (moving image) reproduction processing, print processing or the like according to the type of media. For example, in the case where media communication consisting of “audio” and “video” communication is performed, the media communication control unit 406 implements a voice call between the operating user of the image forming apparatus 101 and the operator of the call center system 102 via the audio I/F control unit 207. Also, in the case where maintenance video (moving image) data is provided from the host computer 103 via the panel control unit 209, the maintenance video (moving image) data is reproduced on the operation panel 216.

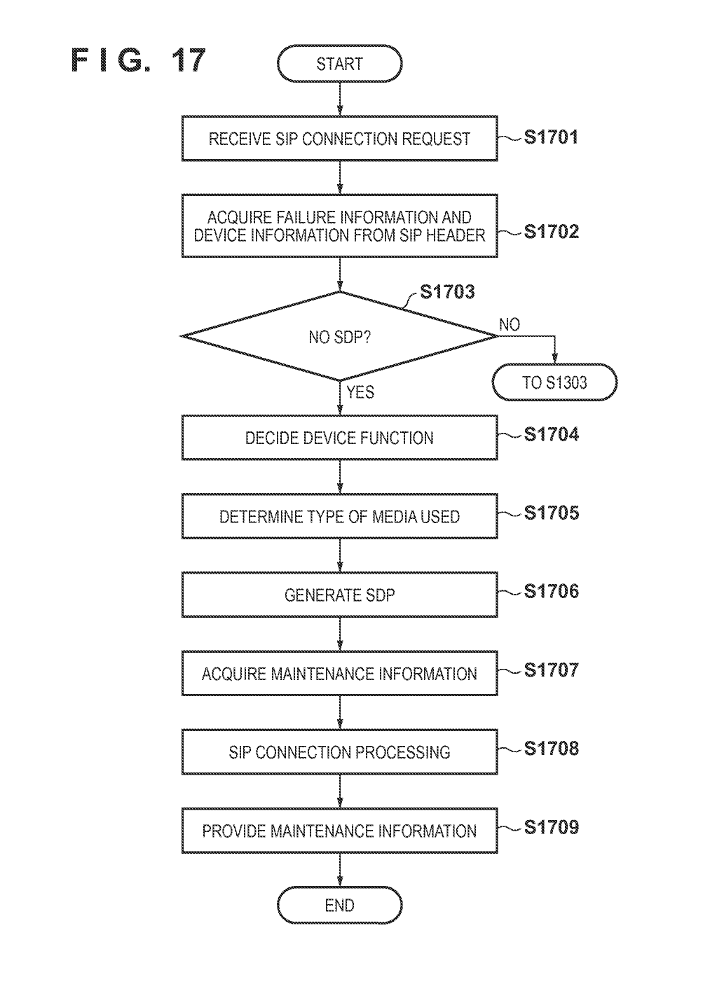

FIG. 17 is a flowchart illustrating a procedure of processing performed when the host computer 103 has received, through the SIP communication control unit 1101, the SIP_INVITE message 1901 from the image forming apparatus 101. Each processing shown in the flowchart is implemented by, for example, a program stored in the ROM 302 being read into the RAM 303 and executed by the CPU 301.

In step S1701, the SIP communication control unit 1101 receives the SIP_INVITE message 1901 via the network I/F control unit 308. In step S1702, the failure information analyzing unit 1104 refers to the User-Agent header 1903 of the SIP_INVITE message 1901 so as to acquire the device state information 801, and identifies the details of the failure that has occurred in the image forming apparatus 101 based on the error code 501. Also, the failure information analyzing unit 1104 identifies the model information of the image forming apparatus 101 based on the model code 701. For example, in the case of the device state information 801 shown in FIG. 8, it can be seen that the image forming apparatus 101 is “MFP-1000”.

In step S1703, the SIP communication control unit 1101 decides whether or not the SIP_INVITE message 1901 contains a body portion 903. If it is determined that the SIP_INVITE message 1901 does not contain a body portion 903, the procedure advances to step S1704. If, on the other hand, it is determined that the SIP_INVITE message 1901 contains a body portion 903, the procedure advances to step S1303, and thereafter the same processing as that of FIG. 13 is performed.

In step S1704, the device function analyzing unit 1103 decides on a function that can be used by the image forming apparatus 101 based on the error code 501, the device configuration code 602 and the model code 701 that are contained in the device state information 801 acquired in step S1302. For example, in the case where the device state information 801 shown in FIG. 8 has been acquired, the image forming apparatus 101 decides that the video (moving image) reproduction function can be used based on the error code 501 and also decides that voice calling is available based on the device configuration information.

In step S1705, the media type determining unit 1105 determines the type of media used in the SIP session established between the image forming apparatus 101 and the host computer 103 based on the function that can be used by the image forming apparatus 101, which was decided on in step S1704. For example, if it is determined in step S1308 that the video (moving image) reproduction function and voice calling are available, the image forming apparatus 101 determines “audio” and “video” as the types of media used in the SIP session. In step S1706, the SDP generating unit 1106 generates a body portion 1503 in which the type of media determined in step S1705 is written as the type of media used in the SIP session in the media descriptive portion 1504.

In step S1707, the maintenance information acquiring unit 1102 acquires from the database 104 the details of the failure and the model information that were identified in step S1702 and the maintenance information corresponding to the type of media used in the SIP session determined in step S1705. For example, if it is determined in step S1705 that “video” is used, maintenance video (moving image) data is acquired.

In step S1708, the SIP communication control unit 1101 generates a 200 OK response message 1501 containing the body portion 1503 generated in step S1706, and transmits the generated 200 OK response message 1501 to the image forming apparatus 101 via the network I/F control unit 308 so as to establish an SIP session. In step S1709, the media communication control unit 1107 performs media communication according to the SIP session controlled by the SIP communication control unit 1101, and performs audio input/output processing, video (moving image) reproduction processing, print processing or the like according to the type of media. For example, in the case where media communication consisting of “audio” and “video” communication is performed, the media communication control unit 1107 implements a voice call between the operating user of the image forming apparatus 101 and the operator of the call center system 102 via the audio I/F control unit 309. Also, in the case where maintenance video (moving image) data is acquired from the database 104, the maintenance video (moving image) data is provided to the image forming apparatus 101.

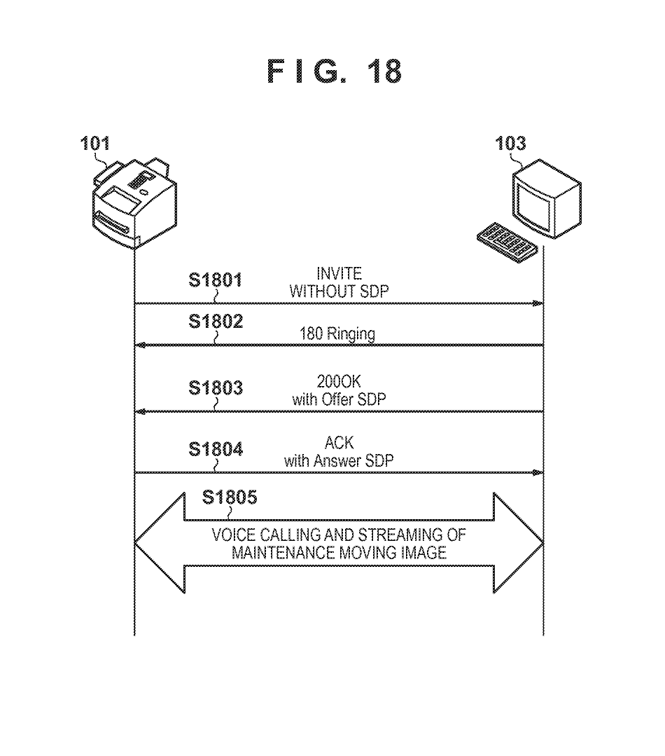

FIG. 18 is a diagram showing an example of a communication sequence between the image forming apparatus 101 and the host computer 103. Hereinafter, FIG. 18 will be described in association with FIGS. 16 and 17. In step S1604, the image forming apparatus 101 transmits an SIP_INVITE message 1901 that does not contain an SDP body portion to the host computer 103 (step S1801). Next, upon receiving the SIP_INVITE message 1901, in step S1701, the host computer 103 returns a 180 Ringing response (step S1802). Next, the host computer 103 performs processing of steps S1702 to S1707, and then in step S1708 returns a 200 OK response message 1501 indicating permission to establish an SIP session (step S1803). Next, upon receiving the 200 OK response message 1501, the image forming apparatus 101 transmits an ACK message 2001 containing an SDP body portion (step S1804) so as to establish an SIP session. When the SIP session has been established, the image forming apparatus 101 and the host computer 103 perform media communication (step S1805). The media communication is performed by, for example, voice calling, streaming of maintenance video (moving image) data from the host computer, or the like.

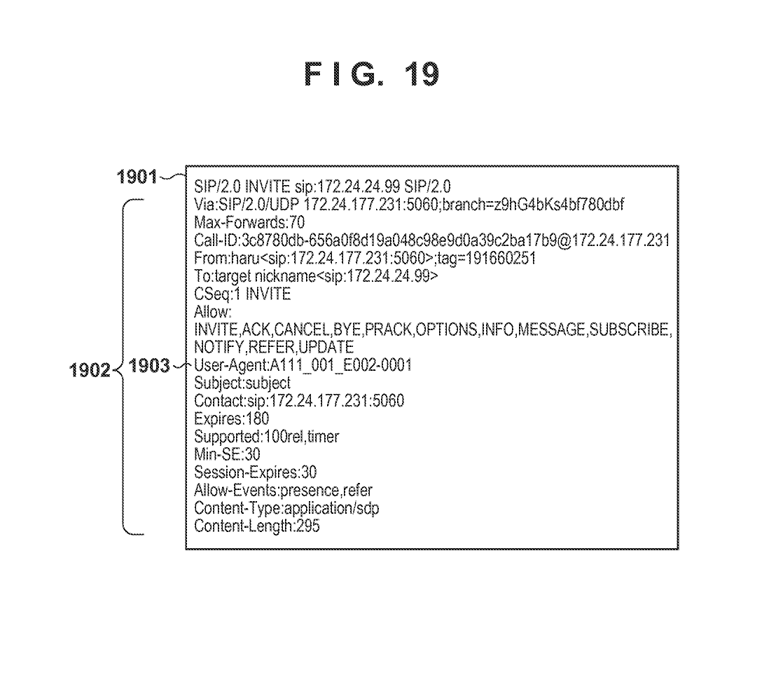

FIG. 19 is a diagram showing an example of the SIP_INVITE message 1901 transmitted by the image forming apparatus 101. A header portion 1902 is an SDP header portion of the SIP_INVITE message. In FIG. 19, the device state information 801 is written in a User-Agent header 1903 of the SDP header portion 1902. Also, as shown in FIG. 19, the SIP_INVITE message 1901 does not contain an SDP body portion. Note that FIG. 19 is merely an example, and thus the content of the SIP_INVITE message is not specifically limited to that shown in FIG. 19.

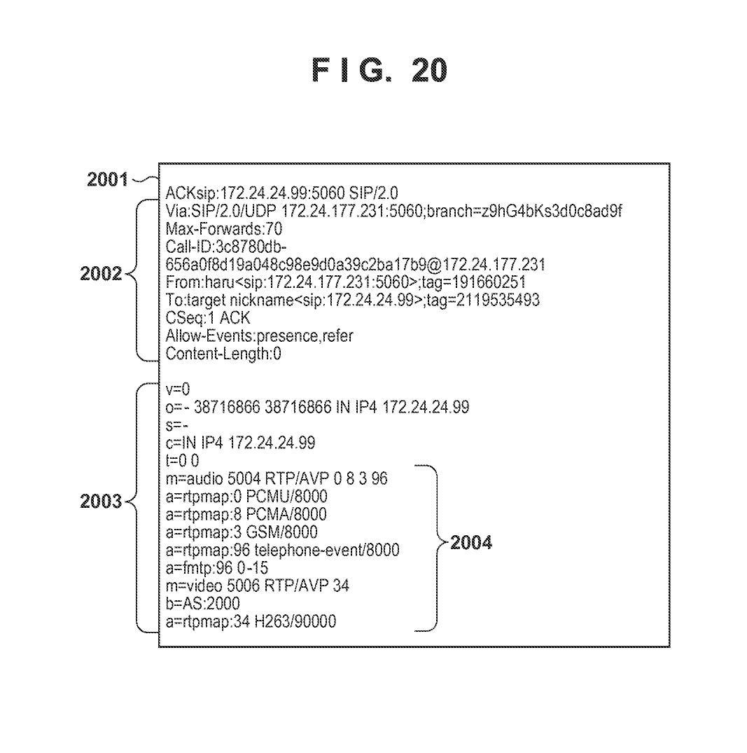

FIG. 20 is a diagram showing an example of the ACK message 2001 transmitted by the image forming apparatus 101. A header portion 2002 is an SDP header portion of the ACK message. A body portion 2003 is an SDP body portion of the ACK message. In a media descriptive portion 2004 of the SDP body portion, the type of media used in an SIP session is written. Note that FIG. 20 is merely an example, and thus the content of the ACK message is not specifically limited to that shown in FIG. 20.

### OTHER EMBODIMENTS

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment (s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-276112, filed Dec. 18, 2012, which is hereby incorporated by reference herein in its entirety.

What is claimed is:

1. An image forming system including: an image forming apparatus including a detecting unit configured to detect a failure and a notifying unit configured to notify an external apparatus of detection of the failure; and the external apparatus including a transmitting unit configured to transmit solving information for solving the failure to the image forming apparatus, the image forming system comprising:
a deciding unit configured to decide on a type of media associated with the failure detected by the detecting unit,
wherein the transmitting unit transmits the solving information to the image forming apparatus by using the type of media decided on by the deciding unit.

2. The image forming system according to claim 1, further comprising a storage unit configured to store failure information regarding the failure detected by the detecting unit in association with the type of media.

3. The image forming system according to claim 1,
wherein the deciding unit decides on the type of media based on device configuration information of the image forming apparatus.

4. The image forming system according to claim 1,
wherein the notifying unit notifies the external apparatus of the type of media decided on by the deciding unit upon detection of the failure.

5. The image forming system according to claim 1,
wherein the type of media is at least one of audio data, moving image data or print data.

6. The image forming system according to claim 1,
wherein the notifying unit executes the notification by using an SIP protocol.

7. An image forming apparatus comprising:
a detecting unit configured to detect a failure;
a deciding unit configured to decide on a type of media associated with the failure detected by the detecting unit; and
a notifying unit configured to notify an external apparatus of the type of media decided on by the deciding unit in response to the failure being detected by the detecting unit.

8. The image forming apparatus according to claim 7, further comprising a storage unit configured to store failure information regarding the failure detected by the detecting unit in association with the type of media.

9. An external apparatus comprising:
a receiving unit configured to receive a notification of a failure from an image forming apparatus;
a deciding unit configured to decide on a type of media associated with the notified failure; and
a transmitting unit configured to transmit solving information for solving the failure to the image forming apparatus by using the type of media decided on by the deciding unit.

10. The external apparatus according to claim 9, further comprising a storage unit configured to store failure information regarding the failure notified from the image forming apparatus in association with the type of media.

11. A communication method executable in an image forming system including: an image forming apparatus including a detecting unit configured to detect a failure and a notifying unit configured to notify an external apparatus of detection of the failure; and the external apparatus including a transmitting unit configured to transmit solving information for solving the failure to the image forming apparatus, the method comprising:
deciding on a type of media associated with a failure detected by the detecting unit; and
transmitting the solving information to the image forming apparatus by using the type of media decided on in the deciding step.

12. A communication method executable in an image forming apparatus, the method comprising:
a step of detecting a failure;
a step of deciding on a type of media associated with the failure detected in the detecting step; and
a step of, in response to the failure being detected in the detecting step, notifying an external apparatus of the type of media decided on in the deciding step.

13. A communication method executable in an external apparatus, the method comprising:
a step of receiving a notification of a failure from an image forming apparatus;
a step of deciding on a type of media associated with the notified failure; and
a step of transmitting solving information for solving the failure to the image forming apparatus by using the type of media decided on in the deciding step.

14. A computer-readable storage medium storing a program for causing a computer to execute:
a step of detecting a failure;
a step of deciding on a type of media associated with the failure detected in the detecting step; and
in response to the failure being detected in the detecting step, notifying an external apparatus of the type of media decided on in the deciding step.

15. A computer-readable storage medium storing a program for causing a computer to execute:
a step of receiving a notification of a failure from an image forming apparatus;
a step of deciding on a type of media associated with the notified failure; and
a step of transmitting solving information for solving the failure to the image forming apparatus by using the type of media decided on in the deciding step.
